(19) United States
(12) Patent Application Publication
(10) Pub. No.: US 2025/0200629 A1
(43) Pub. Date: Jun. 19, 2025

(54) FAI MODEL DRIVEN RECOMMENDATION SYSTEM AND METHOD

(71) Applicant: CloudBlue LLC, Irvine, CA (US)

(72) Inventors: Enric MARTOS, Barcelona (ES); Juan Carlos AUGE ROS, Barcelona (ES); Hernán GIRARDI, Sant Feliu de Llobregat (ES); Jamie Uciel COHEN COHEN, Sant Adria de Besos, Barcelona (ES)

(21) Appl. No.: 18/538,630

(22) Filed: Dec. 13, 2023

(51) Int. Cl. G06Q 30/0601

(52) U.S. Cl. CPC G06Q 30/0631

(57) ABSTRACT

Automated recommendation systems and methods provide product recommendations using a server, a processor, and including an AI Microservice. The AI Microservice receives user recommendation requests containing account identifiers and Service Plan IDs and retrieves historical sales data and pre-calculated association rules, applying Business Filters to align with business rules. Recommendations are generated using these rules and sales data, and then transformed into a Service Plan ID output array. This array is presented to users via a Frequently Bought Together (FBT) interface. The AI microservice employs an ensemble AI model that utilizes both reseller-specific and aggregated data to refine recommendations. This system ensures efficient, personalized product suggestions for users, streamlining the shopping experience.

### BACKGROUND

Conventionally, the CMP relied on manual processes to suggest frequently bought together (FBT) products, commonly referred to as x-sell recommendations. These manually curated recommendations were often a result of observation, intuition, or some form of database referencing, but lacked the depth and accuracy that automated systems could offer. Conventional methodologies require individuals to manually identify products that were often purchased together and then configure the CMP to display these as recommendations. This process was labor-intensive, prone to errors, and often didn't capture the true nature of customer purchase behaviors.

However, manual configuration processes are tedious and time-consuming. This results in high operational costs for businesses and introduced the potential for human errors or biases. Moreover, individuals involved in arranging manual x-sells might not have a comprehensive understanding of entire purchase histories of products. Without a comprehensive view, resulting recommendations might not be the most relevant or beneficial for customers. Further, manually updating these recommendations to stay current with evolving customer preferences was a significant challenge. Moreover, manual methods and even conventional automated methods do not scale or adapt quickly enough to the dynamic nature of online marketplaces. For example, newly listed products, having no or little transaction history, often got overlooked by traditional automated systems.

### BRIEF SUMMARY OF THE INVENTION

Embodiments described herein revolutionize the CMP by generating dynamic FBT product recommendations using an AI model-driven approach. The AI model-driven recommendation system and method stand distinctly apart from traditional systems by leveraging a combination of deep learning and reinforcement learning techniques to continuously refine and adapt its recommendations based on real-time data.

The recommendation system can provide a multi-layered neural network trained on a vast dataset encompassing transactional data, product reviews, search queries, and browsing histories. This neural network extracts patterns and correlations that might be too complex or subtle for traditional algorithms to detect. By employing deep learning, the system can discern intricate relationships between products, ensuring relevant and context-aware FBT recommendations.

In some embodiments, the recommendation system employs distributed computing resources to achieve scalability. As the CMP expands, the system can allocate more computational power as needed, ensuring timely and efficient recommendation generation regardless of the data volume.

In some embodiments, the recommendation system can integrate reinforcement learning. As users interact with the FBT recommendations—clicking on them, ignoring them, or purchasing products—the system receives this feedback as rewards or penalties. The iterative feedback loop enables the recommendation system to fine-tune its recommendation strategies over time, leading to increasingly relevant suggestions.

In some embodiments, the recommendation system can utilize user clustering to achieve personalization. In some embodiments, The AI model segments users based on their behaviors, preferences, and purchase histories, ensuring each user receives tailored FBT suggestions. This not only increases the likelihood of a purchase but also enhances the user experience. To minimize overfitting seen in conventional systems, the recommendation system can incorporate regularization techniques, ensuring the system doesn't overly rely on short-term trends but instead makes recommendations based on a more holistic view of the data. New product listings, which often went unnoticed in traditional systems, are given special attention. The system employs a “cold start” algorithmic approach that gives new products a temporary boost, increasing their visibility in FBT recommendations until sufficient transactional data is collected. The recommendation system also provides transparency that is lacking in conventional systems, providing to vendors and marketplace operators. In some embodiments, the system provides a dashboard displaying metrics and rationale for specific product pairings. Thereby, the AI model-driven recommendation system and method described herein provide a sophisticated, scalable, and transparent solution that addresses the limitations of conventional automated recommendation methodologies, for implementing in an efficient, personalized, and reliable CMP platform.

In some embodiments, the system uses an AI model to automatically generate FBT product recommendations, addressing inefficiencies from manual configurations. The recommendation engine (RE) is a component of the AI microservice. It uses input data from the cloud marketplace platform and can be adapted for other data sources. The approach is universal and can apply to various recommendations.

The AI microservice flow includes data collection from a BSS database, periodic updates, and storage in Azure Blob Storage. The training phase, initiated via specific Python training scripts, reads reports uploaded by a Rated Date Export (RDE). Upon completion, the association rules are stored in the AI DB. In some embodiments, two datasets support the Frequently Bought Together section: orders and resources. The model consists of two models: the individual model, which trains on each reseller's selling data, and the all model, which standardizes Service Plans using all data. Both models are configured to store outputs in the AI DB. Recommendations can be performed based on the outputs. After applying business filters, high quality recommendations can be returned.

In some embodiments, a Rosetta table translates hash IDs to planIDs, providing a bridge between datasets. It includes information about the category, price, and vendor ID of plans. An exemplary algorithm for the Rosetta table can include creating a table with each planID and its resources, cleaning these resources, and generating a hash. This table then enriches with more information and stores in a database. Thereby, the disclosed AI system automates the process of generating frequently bought together product recommendations, enhancing the efficiency and accuracy of recommendations in a CMP.

### BRIEF DESCRIPTION OF THE DRAWINGS/FIGURES

FIG. 1 is an example operating environment of an Automatic FBT Recommendation System, according to some embodiments;

FIG. 2 is an illustration of an Automatic FBT Recommendation System, according to some embodiments;

FIG. 3 is a flow diagram of a method for performing automated FBT recommendations in a CMP platform, according to some embodiments;

FIG. 4 is a flow diagram of a method for performing automated FBT recommendations in a CMP platform, according to some embodiments;

FIG. 5 is a flow diagram of a method for performing automated FBT recommendations in a CMP platform, according to some embodiments;

FIG. 6 is a flow diagram of a method for performing automated FBT recommendations in a CMP platform, according to some embodiments;

FIG. 7 is a flow diagram of a method for performing automated FBT recommendations in a CMP platform, according to some embodiments;

FIG. 8 is a block diagram of example components of device, according to some embodiments of the present disclosure.

### DETAILED DESCRIPTION OF THE INVENTION

Embodiments may be implemented in hardware, firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices, and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

It should be understood that the operations shown in the exemplary methods are not exhaustive and that other operations can be performed as well before, after, or between any of the illustrated operations. In some embodiments of the present disclosure, the operations can be performed in a different order and/or vary.

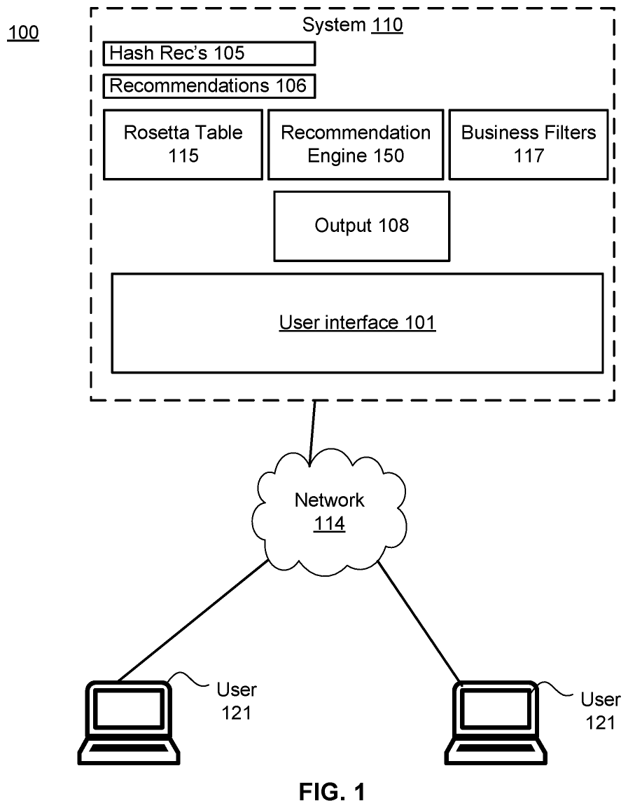

FIG. 1 illustrates an embodiment of an environment 100 for delivering recommendations using a trained model. A user accessing the system through a user interface, e.g., user interface 101, interacts with the environment by making a request for recommendations related to a specific Service Plan ID (e.g., SP 123). The request may indicate a desire to retrieve recommendations for Service Plan 123.

Within the environment 100, this system implementation involves a meticulously trained model designed to facilitate user interaction and deliver tailored product recommendations. User engagement commences through REST API calls directed at an exposed endpoint, containing vital input parameters: the requested Service Plan ID (referred to as PlanID), the Reseller Account (Vendor_Account_ID), and the desired quantity of recommendations. As an illustrative example, consider a user that is a reseller who has acquired the requisite data, and a model previously trained. The user requests recommendations initiating contact with the Recommendation Engine by invoking the exposed API. The engine receives a Service Plan ID provided by the user and applies pre-calculated association rules and applies business logic. An array of Service Plan IDs can be processed and output to meet predefined business filters. These filters ensure that the recommended products integrate with the Reseller Catalog, maintain distinct product categories from the antecedent, and adhere to a price limit (e.g., not surpassing 40% of the antecedent's price). Presented recommendations afford resellers the flexibility to include or exclude items based on personal preferences. Upon finalizing these adjustments, the reseller confirms their choices in the customary manner, and the recommendations can be output to a Product page of the specified Service Plan. This user-centric approach epitomizes the system's commitment to enhancing the decision-making processes of resellers in an efficient and privacy-conscious manner.

Upon making a request, system 110 retrieves specific data from a user via user interface 101. User inputs can include an account and plan (e.g., AccountID ABC and PlanID 123) to be processed by Rosetta table 115. Rosetta table 115 processes the input data and prepares it for further stages in the recommendation generation process. Rosetta table 115 provides an interface between original Plan IDs and securely hashed counterparts, ensuring data privacy and efficiency. Upon receiving inputs such as an Account ID (e.g., “ABC”) and a specific Plan ID (e.g., “123”), Rosetta table 115 provides the Plan ID sought by the reseller for recommendations and a secure hash of the Plan ID, safeguarding sensitive data while enabling access to valuable recommendations.

As shown in FIG. 1, for determining relevant recommendations, Rosetta 115 fetches pre-calculated association rules from hash recommendations 105 and recommendations 106. These data sources facilitate recommendations relevant and meaningful to the requestor (user 121).

Before delivering these recommendations to user 121, a series of Business Filters 117 are applied. These filters serve a dual purpose: ensuring the recommendations are relevant to user 121's original request and adhering to specific business rules. In a non-limiting example, the business rules can include criteria such as ensuring the recommendations are active in the Reseller Catalog, the categories of both the requested and recommended products are different, and that the price of the recommended Service Plan (consequent) isn't more than a certain percentage (e.g., 40%) of the price of the originally requested Service Plan (antecedent).

Once these filters are applied and the final set of recommendations is generated, the results are sent as an Output 108, which can be an array of Service Plan IDs. This array represents recommendations that can be communicated to user 121 in a FBT display/interface. The recommendations are not required to be static. User 121 can be enabled to add or delete any recommendation from this the FBT interface based on his or her discretion. Once user 121 finalizes a selection, these recommendations are displayed on a Product page of the Service Plan. This environment provides a systematic and efficient way to harness pre-existing association rules, apply necessary business logic, and deliver curated recommendations to the end user.

System 110 can include a recommendation engine 150 to perform one or more processes to automate FBT recommendations for CMP. For example, the system can leverage an AI Microservice to compute an AI model that determines FBT product recommendations using historical sales data. This data is extracted periodically by the Data Collection Component from a Business Support System Database. Once extracted, the data is stored in Azure Blob Storage in report format. The reports may include datasets such as “Orders” and “Resources,” which provide transactional data and service plan details, respectively. An ensemble AI model, consisting of an Individual model and an All model, is trained using this data. In some embodiments, the AI model can use a Frequent Pattern (FP)-Growth algorithm to determine frequently bought together product pairs, refining recommendation efficiency and accuracy.

The training component can be used in embodiments herein to identify frequent itemsets in a given dataset, for example, for market basket analysis. The algorithm can identify patterns of items that co-occur frequently within the transactional dataset. This provides an unconventional advantage in understanding consumer behavior in terms of product combinations frequently bought together.

In traditional methods like the Apriori algorithm, the identification of frequent itemsets requires multiple scans of the entire database. This process becomes computationally expensive as the size of the dataset increases. In embodiments described herein, an FP-Growth algorithm can be used to address this by using a two-step process that eliminates the need for candidate generation and multiple scans of the database.

In a first step, the algorithm scans the dataset once to find the frequency of each item. These items are then sorted in descending order based on their frequency. The second step can include constructing an FP-tree, a compact data structure that encapsulates information about frequent itemsets in the dataset. The tree is built by inserting each transaction into it, maintaining the order of frequency of the items. Each node in the FP-tree represents an item, and a counter on each node keeps track of the frequency of that item's occurrence.

To find the frequent itemsets, the FP-Growth algorithm starts at the bottom of the FP-tree and explores paths that lead back to the root. These paths collectively represent a set of frequent itemsets. Each path is analyzed recursively, and a conditional FP-tree is generated to explore all possible combinations of frequent itemsets.

In some embodiments, the FP-Growth algorithm's parameters are substantially involved in training the AI model. For example, in the Individual model a minimum support value can be dynamically computed based on specific metrics like the 25th percentile of a reseller's sales during the training date range. This allows the algorithm to adapt to variations in the data, providing a fine-tuned model. Additionally, for general models like the All model a constant minimum support value, for instance, 0.00001, can be employed to ensure broad applicability.

The Training Component retrieves these reports from the storage to initiate the training process. The resulting association rules, which include product pairings and their respective lift ratios, are stored in the AI Database. The Recommendation Engine, upon receiving a recommendation request, retrieves these association rules, applies relevant business filters, and then sends out the final FBT recommendations.

The network 114 is any network or combination of networks of devices that communicate with one another. For example, the network 114 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user 121 systems 121 might communicate with the system 110 using TCP/IP and, at a higher network level, use other common Internet protocols to communicate, such as HTTP, FTP, AFS, WAP, etc. In an example where HTTP is used, the customer systems 212 might include an HTTP client commonly referred to as a “browser” for sending and receiving HTTP messages to and from an HTTP server at the system 216. Such an HTTP server might be implemented as the sole network interface between the system 216 and the network 214, but other techniques might be used as well or instead. In some implementations, the interface between the system 216 and the network 214 includes load sharing functionality, such as round-robin HTTP request distributors to balance loads and distribute incoming HTTP requests evenly over a plurality of servers.

In one embodiment, the system 110, shown in FIG. 1, implements a recommendation generation mechanism. For example, in one embodiment, system 110 includes application servers configured to implement and execute FBT automation applications as well as provide related data, code, forms, webpages and other information to and from the customer systems 121 and to store to, and retrieve from, a database system related data, objects, and order fulfillment content. With a automated FBT recommendation system, data for multiple consumers may be stored in the same physical database object, to facilitate analytics processes to identify buying patterns and trends.

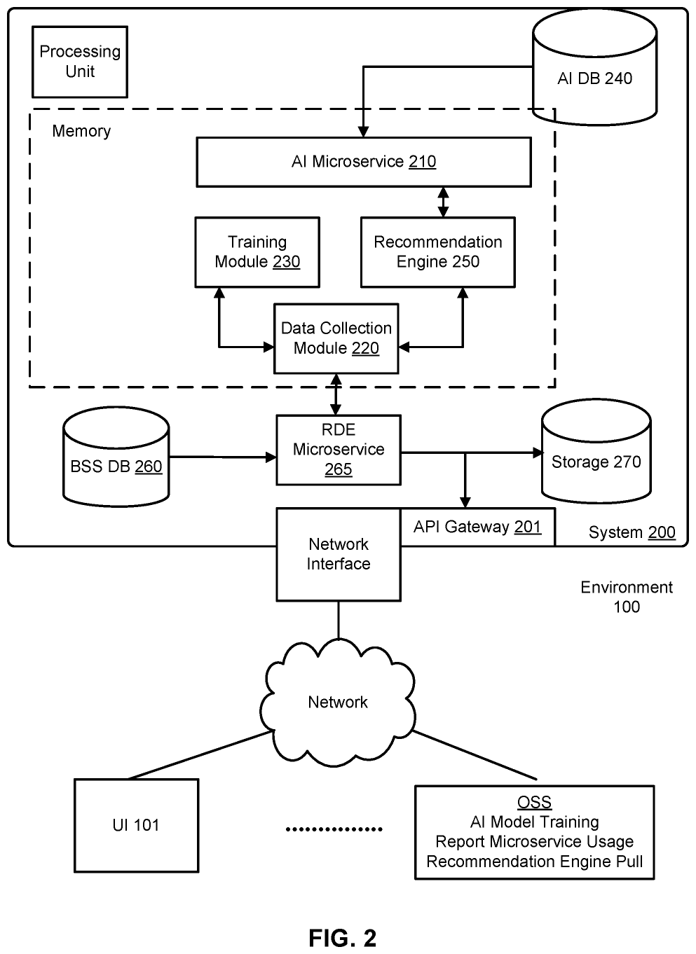

FIG. 2 depicts an embodiment of an Automatic FBT Recommendation System 200 for CMP. System 200 comprises an AI Microservice 210, Data Collection Module 220, Training Module 230, AI Database (AI DB) 240, and Recommendation Engine (RE) 250. In some embodiments, the system interfaces with an external Business Support System (BSS) Database 260 and Azure Blob Storage 270.

In an embodiment, AI microservice 210 can be operably connected to communicate with various components, as described in detail below, to more effectively automate FBT product recommendations for CMP. AI Microservice 210 can store one or more scripts (e.g., Python scripts or the like) to compute an AI model for generating FBT product recommendations. AI Microservice 210 can receive input data from BSS Database 260, which may hold historical sales data. AI Microservice 210 can communicate with Data Collection Module 220 to gather necessary training data.

Data Collection Module 220 can execute a periodic task (e.g., an Open Source Software (OSS) scheduled task), for example, via Application Programming Interface (API) Gateway 201 to extract historical sales data from BSS Database 260. This extracted data, based on an adjustable time window (e.g., last 12 months), can be uploaded to Azure Blob Storage 270 as a report. The datasets that RE 250 can use may include “Orders,” which holds transactional data, and “Resources,” containing details about Service Plans. These datasets can feed training of an ensemble AI model, composed of two parts: an Individual model and an All model. Both models apply the FP-Growth algorithm, with different minimum support levels and lift thresholds. Once trained, the model can identify product pairings that customers frequently buy together, enhancing the efficiency and accuracy of product recommendations. The extracted data can be provided in rotation, i.e., replacing old files with new ones bearing the same name, such as orders.csv and resources.csv. In some embodiments, Data Collection Module 220 can be configured to extract data from BSS Database 260 and upload it to Azure Blob Storage 270.

Training Module 230 initiates a training process via a specific instruction, for example a Python (.PY) file, containing training scripts. Upon launch, it retrieves and reads the uploaded reports from Storage 270, and subsequently updates AI DB 240 with generated association rules. In some embodiments, Training Module 230 can read data from Azure Blob Storage 270 and updates AI DB 240.

AI DB 240 stores association rules generated by the AI model. These rules may include antecedents, consequents, and lift ratios and serve as the basis for product recommendations. In some embodiments, AI Microservice 210 can communicate with AI DB 240 to retrieve association rules.

RE 250 can be included as a component of AI Microservice 210 and can be configured to retrieve the association rules from AI DB 240 when a FBT recommendation request is made. RE 250 can apply one or more business filters before finalizing and transmitting recommendations. In a non-limiting example, external BSS Database 260 can be a PostgreSQL data source that provides historical sales data for the CMP. This data source could be generalized for other data sets and is not restricted to BSS Database 260 In some embodiments, RE 250, part of AI Microservice 210, can retrieve data from AI DB 240 and apply business filters to provide FBT recommendations.

The model supporting the computation of the association rules can adopt an ensemble approach comprising two distinct models:
Individual Model: This model trains using the selling data of each individual reseller.
All Model: This model utilizes a standardized version of the Service Plans, allowing it to use the entirety of the data for training. Each of these models produces outputs stored in the AI DB. These outputs represent antecedents (products purchased), consequents (products bought alongside the antecedent), and the lift ratio. When a reseller requests a recommendation, both models retrieve their respective recommendations. After applying business filters, the system returns the most optimal recommendations.

The solution doesn't require testing post-learning because it applies a probabilistic model. This method can exclusively extract product pairs that are most likely to be purchased together, pruning less significant ones using the minimum support hyperparameter. If numerous customers buy a product in tandem with product B, these results get validated by Product Management and other experts. If the results seem unsuitable, adjustments are made to the support value parameter.

Storage 270 can be configured to store historical sales data reports (orders.csv and resources.csv) which are used by Training Module 230 for model training. In an example, Storage 270 can be configured as an Azure Blob storage element to store orders.csv and resources.csv.

In a non-limiting example, AI Microservice 210 can be a Java based microservice exposing one or more endpoints, including:
POST/update-train: Used to update or train the AI model;
GET/recommendations: Retrieves FBT product recommendations; and
GET/business-metrics: Obtains metrics related to business operations.

Continuing the example, AI Microservice 210 can interface with an API Gateway 201, which further connects to a branding user interface module (e.g., UI 101), OSS Scheduled Tasks, such as “AI Model training task,” which can be configured to trigger periodically (e.g., on the 28th day of every month), and “Report microservice usage data,” which can be configured to trigger periodically (e.g., every Saturday). In an embodiment, The API Gateway 201 also connects to another OSS Scheduled Task labeled “Recommendation Engine Pull,” which triggers on the 27th day of every month.

System 200 can be configured to execute a Python script (e.g., “training_script.py”) Python. This script can include instructions for interfacing with an AI-DB, e.g., a PostgreSQL database, for storing and retrieving AI model data. Storage 270 (e.g., Azure Blob storage) can include data extracted from BSS database 260 by Reporting and Data Export (RDE) Microservice 265. RDE Microservice 265 can communicate with BSS Database 260 and performs data reporting and export. It enables resellers to generate and export various types of reports, each focusing on different aspects such as rated transactions, payment and refund transactions, user accounts, login history, and more.

In an embodiment, RDE 265 aggregates data from both BSS and OSS databases. It provides data sets for multiple report types, including but not limited to: “Rated transactions,” “Payments,” “Accounts,” “Login History,” “Subscriptions,” “Service Users,” “Staff Members,” “Non-provisioned Orders,” “Subscription Resources,” “AR Documents,” “Invoices,” “Service Plans,” and “Service Plan Resource Rates.”

RDE 265 can generate and export reports in multiple formats, including XML, CSV, XLSX, and JSON. Reports can be generated on demand or according to a defined schedule. For example, RDE 265 exposes a POST/pull-recommeng-dataset endpoint, which allows for the retrieval of specific datasets required for recommendation generation. These datasets, once retrieved, can be stored in Storage 270 in forms such as orders.csv or resources.csv.

The reports generated by RDE 265 offer granular insights, which can be particularly beneficial for the training of the AI model in Training Module 230. For instance, the “Rated Transactions” report can provide detailed information about all types of applied charges to a specific account within a specified period, and costs for both participants of the transaction. This data is used by the AI model to learn about customer behavior patterns and purchase histories. In an embodiment, RDE 265 can be configured to automatically update these reports in Azure Blob Storage 270, which can then be accessed by Training Module 230 for subsequent AI model training.

RDE 265 also interfaces with the API Gateway 201 and can be triggered to pull data from BSS Database 260 at scheduled intervals. In a non-limiting example, RDE 265 can be a microservice based on Java or another suitable programming language, providing a single, logically-bound functionality extending the UX1 interface.

The integration of RDE 265 into System 200 enhances the system's data collection capabilities. It provides a mechanism to collect a wide array of transactional and behavioral data necessary for the efficient functioning of the AI model, thereby directly contributing to the system's ability to make more accurate FBT product recommendations.

In an embodiment, data collection can begin with the extraction of historical data from BSS DB 260 (e.g., by the RDE component). This data can be stored in the Azure Blob Storage (Storage 270) in the form of .CSV files, namely orders.csv and resources.csv. Periodically, the AI model gets updated using this data. The training script reads the reports, processes the data, and generates association rules that are then stored in the AI DB. AI Microservice 210 then use updated model to provide FBT product recommendations when queried.

A Rosetta table can be provided as a translation dictionary, linking hash IDs with their respective planIDs. This table also stores information about the plan's category, its pricing, and the vendor ID. Knowing both the planID and Vendor Account ID allows for accurate recommendation returns. A table with each planID and its resources is generated. These resources undergo cleansing into a set, with duplicates removed and the set sorted. The algorithm identifies duplicate lines, automating their removal. Subsequently, a unique string is generated which serves as an input to a hashing function. This produces a table mapping each Service Plan (SP) to a hash. Additional enrichments to this table include pricing details (setup fee and recurring fee), category, vendor account, and other related data. The finalized table stores in the database for utilization.

To generate the Rosetta table, the following algorithm can be employed:
A table mapping each planID to its resources is created.
Resources get cleaned into a set, eliminating duplicates and sorting them. A dedicated script identifies and removes duplicate rows automatically.
A string is subsequently generated. This string, when combined with a specific seed, acts as input to a hashing function to produce a consistent hash.
A table relating each Service Plan (SP) to its hash is developed.
Additional data, such as pricing (setup fee+recurring fee), category, vendor account, and related information, enriches the table.
The finalized table gets saved to the database for future use.

In some embodiments, the individual model offers a personalized modeling approach by using the sales order data specific to each reseller. The primary advantage ensures every reseller receives a minimum of one recommendation. More specifically, in a non-limiting example, a min_support parameter can define a floating-point value ranging between 0 and 1. The min_support parameter defines the minimum support required for an itemset to be considered frequent in the dataset. A lower min_support value results in more itemsets being considered frequent, which in turn increases the likelihood of generating recommendations. Conversely, a higher min_support value makes the criteria stricter, potentially reducing the number of recommendations. Adjusting this parameter can allow for fine-tuning of the recommendation system to better suit specific reseller needs and preferences.

System 200 is configured to automate the process of generating product recommendations, ensuring they are based on the latest sales data and accurately reflect buying trends. This automation aims to improve efficiency, reduce operational costs, and provide more accurate product recommendations based on historical purchase data. The system is scalable and can be adapted for different types of recommendation algorithms beyond FBT by developing new models and opening new APIs for communication.

Several elements in the system shown in FIGS. 1 and 2 can include conventional, well-known elements that are explained only briefly here. For example, each of the user 121 systems could include a desktop personal computer, workstation, laptop, PDA, cell phone, or any wireless access protocol (WAP) enabled device or any other computing device capable of interfacing directly or indirectly to the Internet or other network connection. Each of the user 121 systems 121 typically runs an HTTP client, e.g., a browsing program, such as Microsoft's Edge browser, Google's Chrome browser, Opera's browser, or a WAP-enabled browser in the case of a cell phone, PDA or other wireless device, or the like, allowing a customer of the user 121 systems to access, process and view information, pages and applications available to it from the system 200 over the network 114. Each of the user 121 systems also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 110/200 or other systems or servers. For example, the user interface device may be used to access data and applications hosted by the system 216, and to perform searches on stored data, and otherwise allow a user to interact with various GUI pages that may be presented to a user. As discussed above, embodiments are suitable for use with the Internet, which refers to a specific global internetwork of networks. However, it should be understood that other networks may be used instead of the Internet, such as an intranet, an extranet, a virtual private network (VPN), a non-TCP/IP based network, any LAN or WAN or the like.

According to one embodiment, each of the user 121 systems and all of its components are operator configurable using applications, such as a browser, including computer code run using a central processing unit such as an Intel Pentium.RTM. processor or the like. Similarly, system 110/200 (and additional instances of an MTS, where more than one is present) and all of their components might be operator configurable using application(s) including computer code to run using a central processing unit such as a processor system, which may include an Intel Pentium.RTM. processor or the like, and/or multiple processor units. A computer program product embodiment includes a machine-readable storage medium (media) having instructions stored thereon/in which may be used to program a computer to perform any of the processes of the embodiments described herein. Computer code for operating and configuring the system 110/200 to intercommunicate and to process webpages, applications and other data and media content as described herein are, for example, downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), micro-drive, and magneto-optical disks, and magnetic or optical cards, Nano-systems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments may be implemented in any programming language that may be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

It should be understood that the operations shown in the exemplary methods are not exhaustive and that other operations can be performed as well before, after, or between any of the illustrated operations. In some embodiments of the present disclosure, the operations can be performed in a different order and/or vary.

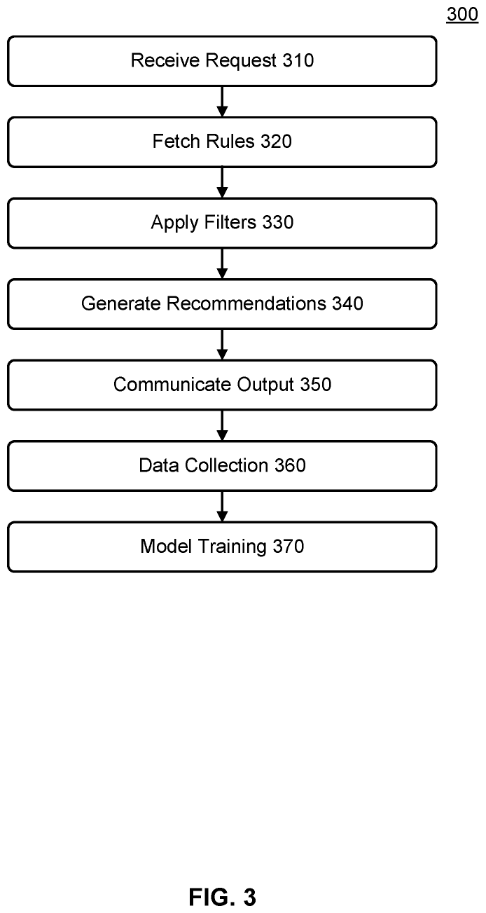

FIG. 3 is a flow diagram of a Method 300 for performing automated FBT recommendations in a CMP platform, according to some embodiments of the present disclosure. In some embodiments, method 300 provides operational steps to deliver product recommendations based on Service Plan IDs using a complex system. In some embodiments, method 300 performs core actions that take place in the environment described above. Based on the disclosure herein, operations in method 100 can be performed in a different order and/or vary.

At operation 310, the system receives a recommendation request from a user. The request often contains specific data, such as an account identifier (AccountID) and a Service Plan ID (PlanID). This data is sent to Rosetta table 115 for processing.

At operation 320, Rosetta table 115 fetches pre-calculated association rules from data sources, Hash recommendations 105 and recommendations 106. These rules help in generating recommendations that are relevant to the user's request. Rosetta table 115 then prepares the data for further processing by transforming it to a format suitable for applying business filters and generating recommendations. Operation 320 can include Rosetta table 115 retrieving pre-calculated association rules from two data sources, namely Hash recommendations 105 and recommendations 106. These association rules play a vital role in generating recommendations that are pertinent to the user's specific request. Rosetta table 115 prepares this data for further processing, including necessary transformations to facilitate the application of business filters and recommendation generation.

At operation 330, a set of Business Filters 117 are applied to the prepared data. These filters ensure that the recommendations align with specific business rules as well as the user's original request. For example, the filters may check that the recommended Service Plans are active in the Reseller Catalog and that their prices do not exceed a set percentage of the originally requested Service Plan. These rules can include criteria such as the active status of the recommended Service Plans in the Reseller Catalog and price considerations, where the price of the recommended Service Plan (consequent) must not exceed a certain percentage of the price of the originally requested Service Plan (antecedent).

Following the application of these business filters, the final set of recommendations is generated at operation 340. This set is converted into an output array of Service Plan IDs, which is referred to as Output 108. At operation 340, the final set of recommendations is generated after applying the Business Filters 117.

At operation 350, the output array is sent to a FBT interface for display to the user. The user has the option to add or remove recommendations according to their preferences.

At operation 360, AI Microservice 210 invokes Data Collection Module 220 to fetch historical sales data from Business Support System Database 260. This data is stored in Azure Blob Storage 270 and used to train the AI model for future recommendations.

At operation 370, Training Module 230 initiates the training process. It retrieves the historical sales data stored in Azure Blob Storage 270 and updates the AI Database 240 with newly generated association rules based on this data.

Following 370, when a new FBT recommendation request comes in, Recommendation Engine 250 fetches the latest association rules from AI Database 240. The engine then applies relevant business filters and sends out the final FBT recommendations. Operation 370 can include Training Module 230 retrieving the historical sales data stored in Azure Blob Storage 270 and utilizes it to update the AI Database 240 with newly generated association rules. These association rules include information about product pairings and their respective lift ratios, forming the basis for future recommendations.

When a new FBT recommendation request is received, the Recommendation Engine 250 retrieves the latest association rules from AI Database 240 and applies relevant business filters. Subsequently, the engine generates and sends out the final FBT recommendations, ensuring that they align with the user's request and adhere to business rules.

In an embodiment, the method uses an ensemble AI model for training, comprising an Individual model and an All model. Both models employ the FP-Growth algorithm. The Individual model trains on data specific to each reseller while the All model uses aggregated data. In a non-limiting example, the Data Collection Module 220 could execute a periodic task to update the historical sales data. Also, the business filters could be updated to include new business rules without affecting the overall functioning of the recommendation system.

In some embodiments, method 300 leverages an ensemble AI model, consisting of an Individual model and an All model, both utilizing the FP-Growth algorithm. The Individual model operates on data specific to each reseller, while the All model uses aggregated data. This approach ensures a personalized recommendation experience and contributes to the system's ability to provide accurate product suggestions. Method 300 thereby delivers personalized, business-rule compliant recommendations for Service Plans. It utilizes a robust architecture involving various components that work in unison, supported by an AI model that continually refines the recommendation process.

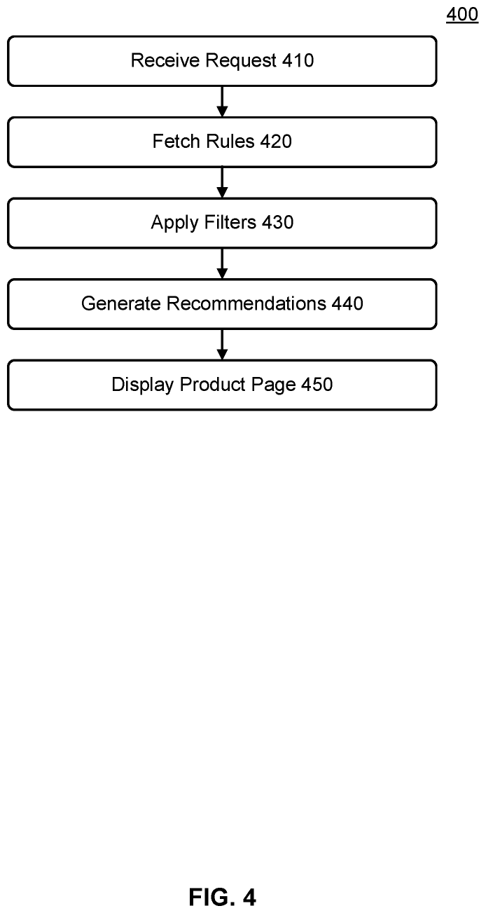

FIG. 4 illustrates Method 400 for processing user requests within the Frequently Bought Together (FBT) recommendation system, where the system performs the following operations:

Operation 410 can include receiving, by the system, a user request, which includes data such as the Service Plan ID (PlanID), Reseller Account (Vendor_Account_ID), and the desired number of recommendations, for example. At operation 410, system 200 extracts the AccountID and PlanID from the user's request. This information can be utilized to identify the user and their specific Service Plan ID.

At operation 420, system 200 retrieves association rules from Hash recommendations 105 and recommendations 106, which are stored in the Rosetta table 115. These association rules are integral to the recommendation generation process, as they provide insights derived from historical transaction data. These rules identify patterns of products that are frequently purchased together by users. Retrieving and utilizing these association rules can ensure that the recommendations generated are properly associated to the user's request.

The association rules themselves consist of antecedents (bought products) and consequents (products frequently bought together with the antecedents). These rules are established through algorithms like FP-Growth, which analyze historical transaction data to identify statistically significant associations between products. By tapping into these pre-computed association rules, the system gains valuable knowledge about product affinities, enabling it to make informed recommendations.

These association rules serve as the cornerstone of the recommendation engine's ability to provide users with product suggestions that are not only based on their initial request but also reflect the historical purchasing behavior of other users. This combination of user-specific requests and data-driven insights ensures that the recommendations generated by the system are both personalized and rooted in empirical patterns of user behavior.

At operation 430, the system meticulously applies a set of Business Filters 117 to the association rules obtained in operation 420. These Business Filters refine recommendations to ensure they accommodate a user's request while adhering to specific business regulations. The Business Filters encompass a range of technical checks and criteria, each serving a distinct purpose:

System 220 may confirm the active status of the recommended Service Plans. It cross-references the recommendations with the reseller's active catalog, ensuring that the recommended products are currently available for purchase. This step prevents users from receiving recommendations for products that are no longer offered by the reseller, ensuring the recommendations are actionable.

System 220 may verify the compatibility of product categories. The system checks that the recommended Service Plans belong to different product categories than the antecedent product. This constraint is enforced to diversify the recommendations and avoid suggesting closely related products, thereby enhancing the user's selection choices.

System 220 may enforce price constraints on the recommendations. Specifically, the system ensures that the price of the recommended Service Plan (consequent) does not exceed a predetermined percentage of the price of the originally requested Service Plan (antecedent). For instance, if the business rule dictates a 40% limit, the system validates that the price of the recommended Service Plan does not exceed 140% of the antecedent's price. This constraint safeguards against recommending products significantly more expensive than the user's initial choice, promoting affordability and user satisfaction.

By applying these Business Filters, the system optimizes generated recommendations to meet the user's specific requirements while aligning with the reseller's business rules.

At operation 440, the system generates recommendations using FP-Growth algorithm trained model data. System 220 employs the FP-Growth algorithm trained model data, which is based on historical transaction data, to efficiently identify common product pairs frequently purchased together. Within the FP-Growth results, the system extracts valuable patterns and associations in the transaction data, revealing relationships between products frequently bought together. Based on the FP-Growth model data, system 220 identifies product pairs that meet predefined support thresholds. These pairs are transformed into product recommendations, prioritizing statistically significant combinations. The generated recommendations can be refined to precisely match the user's request and business filters. This customization ensures recommendations meet specific criteria like product availability, category compatibility, and price limits. Despite the complexity, the algorithm provides real-time or near-real-time responses to user requests, ensuring prompt delivery of tailored recommendations.

Thereby, method 400 implements FP-Growth algorithm trained model data to identify product associations and generate tailored recommendations. These recommendations are rooted in empirical patterns within historical data and are fine-tuned to meet user preferences and business requirements. This data-driven approach consistently delivers relevant recommendations within the Frequently Bought Together (FBT) recommendation system, enhancing the user experience.

At operation 450, system 200 transmits the generated recommendations to a user interface, allowing the user to view and interact with the suggested products. Users can add or remove recommendations based on their preferences.

These operations collectively form Method 400, which provides a detailed, technical process for delivering personalized and business-rule-compliant recommendations for Service Plans within a complex system designed for a CMP.

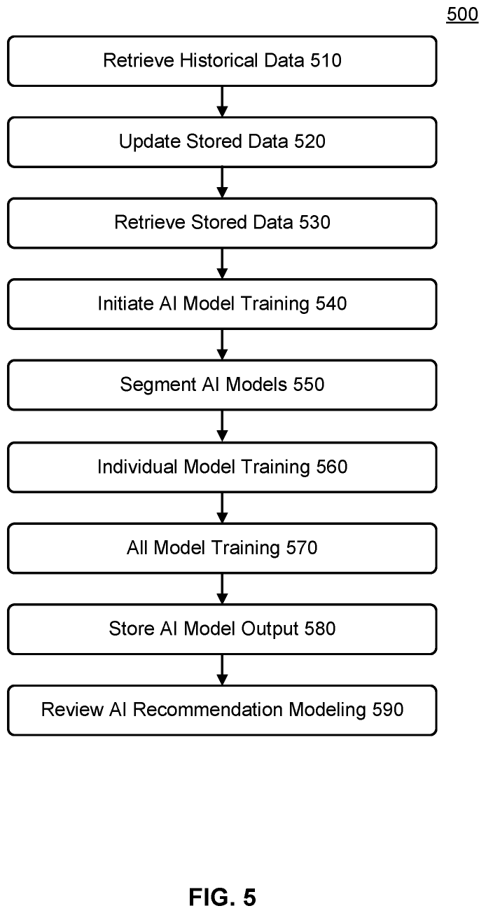

FIG. 5 depicts a flow diagram of a Method 500 for model training in the automated FBT recommendation system within the CMP environment. This figure illustrates the systematic process of training an AI model to enhance the efficiency and accuracy of product recommendations based on historical sales data.

At operation 510, Data Collection Module 220 extracts historical sales data from the BSS Database 260. The data includes transactional records related to Service Plans. This information is transferred to Azure Blob Storage 270 and stored as datasets named “Orders” and “Resources.”

At operation 520, Data Collection Module 220 can execute one or more scheduled tasks to periodically update the sales data stored in the BSS Database 260. The updated data is also transferred to Azure Blob Storage 270 to ensure the AI model uses current information for training.

At operation 530, AI Microservice 210 can retrieve the historical sales data stored in Storage 270. The data is in the form of datasets and includes information about Service Plans and customer transactions. The Microservice uses this data as input for model training.

At operation 540, AI Microservice 210 uses the datasets “Orders” and “Resources” as the basis for training the AI model. The Microservice employs machine learning algorithms to analyze the datasets and generate predictive models.

Operation 540 can include a process 550 whereby AI Microservice 210 segments two sub-models based on the datasets. An Individual Model can be personalized for each reseller and uses sales data unique to that reseller for predictions. An All Model can be a more generalized model trained on the aggregated data from all resellers.

At operation 560, the Individual Model uses sales data specific to each reseller. The model employs the FP-Growth algorithm to identify frequent itemsets. The algorithm uses a parameter called “min_support,” a numerical value representing the minimum frequency an itemset must have to be considered frequent in the dataset. In a non-limiting example, the Individual Model can employ the FP-Growth algorithm. This algorithm takes the 25th percentile of each reseller's sales frequency as the value for the “min_support” parameter, which is a floating-point number between 0 and 1. The algorithm then scans the transaction data for frequent itemsets that meet or exceed this threshold. The output is a set of association rules represented as antecedent, consequent, and lift ratio values.

At operation 570, the All Model uses the complete dataset for training, unlike the Individual Model. This model also uses the FP-Growth algorithm but may use different settings for parameters like minimum support levels and lift thresholds. In an example, the All Model also uses the FP-Growth algorithm but sets a constant “min_support” value of 0.00001. Because it uses an aggregated dataset, the All Model produces statistically stronger association rules. After the models are trained, AI Microservice 210 can provide the output into the AI Database 240.

At operation 580, output from the Individual and All Models is stored at AI Database 240. The data stored includes antecedents, consequents, and lift ratios. These elements serve as the basis for generating FBT product recommendations. In an example, each output is tagged with metadata including the model type (Individual or All), along with the antecedents, consequents, and lift ratios. This output is stored in a table optimized for quick retrieval of association rules.

If the recommendations do not align with expectations, they adjust the “min_support” parameter and re-run the models. This iterative approach ensures the model's outputs meet the desired criteria. At operation 590, Product Management and other experts can review the outputs of the AI models. They have the authority to adjust parameters like “min_support” based on the quality and relevance of the recommendations generated.

Notably, the process doesn't require post-learning testing because it employs a probabilistic model. This approach focuses on extracting product pairs that are most likely to be purchased together, eliminating less significant ones using the minimum support hyperparameter. If numerous customers consistently buy two products in tandem, the results are validated by Product Management and other experts. Adjustments can be made to the support value parameter if necessary to fine-tune the recommendation system.

Thereby, method 500 performs ensemble AI model using historical sales data to generate FBT product recommendations within the CMP environment. This training process ensures that the recommendation system continually evolves to provide accurate and relevant recommendations to users based on their behavior and preferences, contributing to improved customer satisfaction and business efficiency.

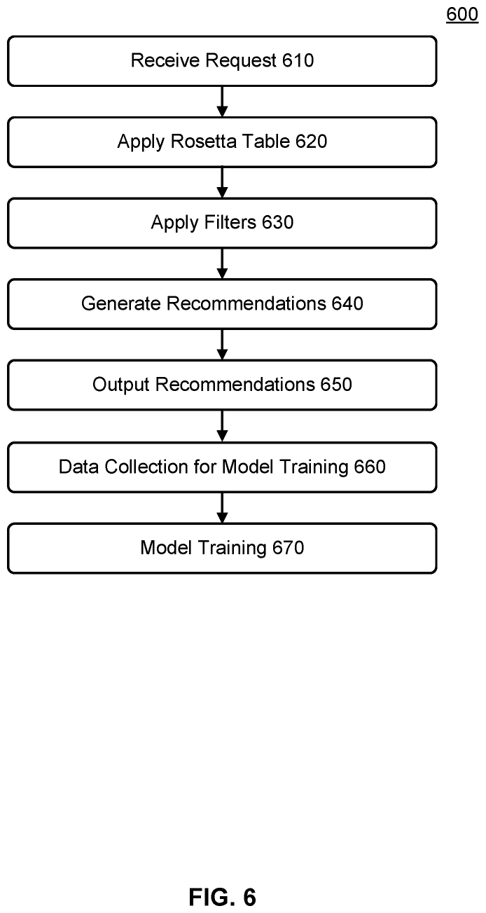

FIG. 6 illustrates method 600 for data collection in an automated FBT recommendation system in a CMP platform. Method 600 starts with the receipt of a recommendation request from a user.

At operation 610, system 200 receives a request, which can includes an Account Identifier (AccountID) and a Service Plan Identifier (PlanID), as described above, for example.

At operation 620, data from the user is processed through a Rosetta table. This table initially contains each PlanID and its resources. A hash function can be applied to create a unique identifier for each processed PlanID. Rosetta table 115 can enrich the PlanIDs with additional attributes like price, category, and vendor account. This table is then used to fetch pre-calculated association rules, including Hash recommendations and other types of recommendations for generating user-specific recommendations. Operation 620 can include system 220 fetching the pre-calculated association rules from two data sources: Hash recommendations 105 and recommendations 106. These association rules enable generating relevant recommendations responsive to the user's request.

Additionally, Operation 620 can include Real-Time Data Augmentation. This process integrates real-time metrics like recently viewed items or real-time inventory levels from an auxiliary database. The real-time data enriches the fetched association rules, making the recommendations current and context-aware.

The data undergoes a transformation at optional operation 630 to prepare it for the application of business filters and for generating recommendations. This ensures that the data is in a format suitable for downstream processes. Operation 630 can apply business filters to the transformed data. These filters align the generated recommendations with both the user's request and certain business rules. The rules could include ensuring active Service Plans in the Reseller Catalog and setting price thresholds for the recommended Service Plans.

At operation 640, the system generates recommendations using either an individual model or an all model. In a non-limiting example, the individual model uses a 12-month (6-month, 24-month, 36-month, or any other period) window of sales data specific to the vendor AccountIDs. It calculates the sales frequency of each Service Plan and applies the FP-Growth algorithm to generate recommendations. The all model also uses a 12-month sales data window but incorporates the Rosetta table to assign hashes to each PlanID. The FP-Growth algorithm is applied, and association rules are created based on these hashes.

The generated recommendations are then delivered to the user at operation 650. These recommendations can be presented via a FBT display/interface, allowing the user to make selections based on their preferences. In this interface, a user has the flexibility to add or remove recommendations based on their preferences. This user-friendly interaction is a key feature of the system, enhancing the user's experience. This set of recommendations is transformed into an output array of Service Plan IDs, referred to as Output 108.

Operation 660 can include data collection for AI model training. AI Microservice 210 instructs Data Collection Module 220 to gather historical sales data from Business Support System Database 260. This data is stored in Azure Blob Storage 270 and can be partitioned based on attributes like geographic location.

Operation 670 entails the training of one or more AI models. Training Module 230 retrieves the historical sales data from Storage 270 and updates the AI Database 240 with newly generated association rules. As above, the AI model comprises two components: an Individual model and an All model. Both components utilize the FP-Growth algorithm to determine frequently bought together product pairs, as detailed in the Individual Model section.

Following model training, system 200 can process new FBT recommendation requests. At this stage, Recommendation Engine 250 fetches the latest association rules from AI Database 240. Business filters can be applied, and final recommendations are generated and provided to the user.

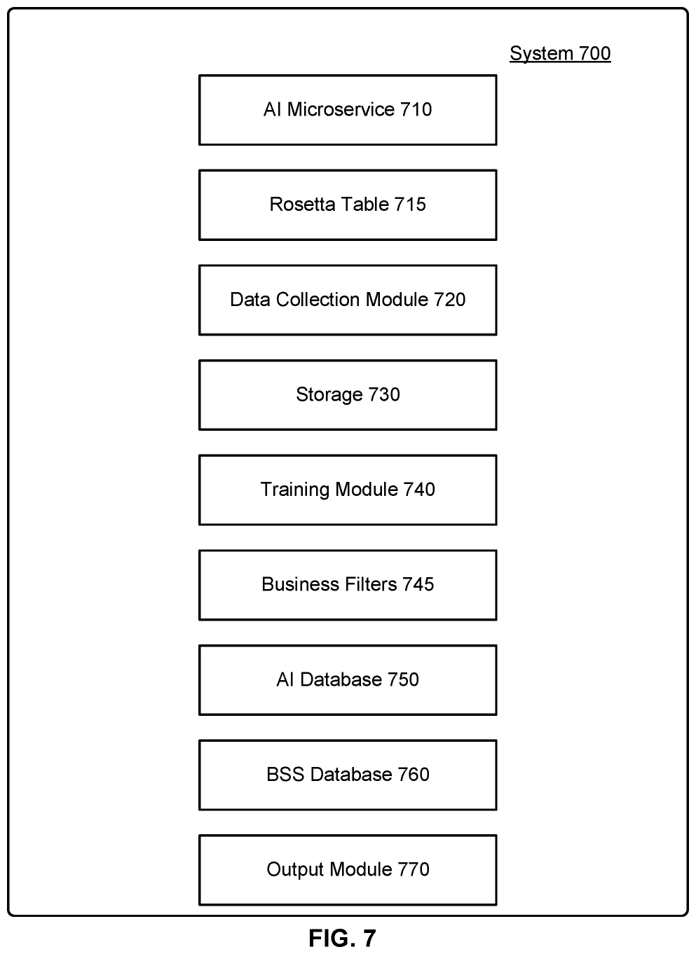

FIG. 7 illustrates exemplary architecture of an automated FBT recommendation engine, according to an embodiment. System 700 architecture provides an automated Frequently Bought Together (FBT) recommendation engine, operating for example within the broader environment discussed earlier, where a user initiates a recommendation request, and the system processes this request.

As shown, FIG. 7 depicts the core elements and processes involved in generating recommendations for Service Plans using a trained model. System 700 can include AI Microservice 710, Rosetta Table 715, Data Collection Module 720, Storage Module 730, Training Module 740, Business Filters 745, AI Database 750, and BSS Database 760. In some embodiments, AI Microservice 710 can execute the AI models and generate the FBT recommendations. Rosetta Table 715 can translate Plan IDs to hash IDs, aiding in data preparation for model training. Data Collection Module 720 can extract historical sales data from BSS Database 760 and upload it to Storage 730. Training Module 740, which uses the FP-Growth algorithm, can fetch this data to train AI models for product recommendations. Business Filters 745 can refine the model-generated recommendations based on predefined criteria. AI Database 750 stores the trained models and other relevant information.

The user's request can include specific data, such as an AccountID and a Service Plan ID (PlanID), which are retrieved for generating personalized recommendations. This input data is initially processed by the Rosetta table 715, which prepares the data for further stages in the recommendation generation process.

AI Microservice 710, housed within the larger system 700, can include Python-based scripts to compute the AI model and generate FBT product recommendations. It is configured to draw input data from the BSS Database 760 but can adapt to alternative data sources.

In a non-limiting example, Data Collection Module 720 can be enabled by OSS scheduled task. This task can trigger execution of SQL queries to extract historical sales data from the BSS Database 760. To manage issues like large data volumes and to maintain data integrity, the component can employ a batch processing approach. It fetches data in smaller segments and uses checksums for post-transfer data validation. Retrieved data, constrained to the last 12 months (6, 24, 36, or any other period) for example can be uploaded to Storage 730 in a .CSV format.

Training Module 740 can employ an FP-Growth algorithm for model training. It employs two models: the Individual model and the All model. As noted above, he FP-Growth algorithm's parameters are involved in training the AI model. For example, in the Individual model a minimum support value can be dynamically computed based on specific metrics like the 25th percentile of a reseller's sales during the training date range. This allows the algorithm to adapt to variations in the data, providing a fine-tuned model. Additionally, for general models like the All model a constant minimum support value, for instance, 0.00001, can be employed to ensure broad applicability.

Therefore, in a non-limiting example, for the Individual model the component dynamically calculates the minimum support value based on the 25th percentile of reseller sales during the specified training date range. On the other hand, the All model operates with a fixed minimum support value of 0.00001. Both models employ “Lift” as the minimum threshold metric with a value of 1.1 and restrict the maximum number of associations to two, which are stored in the AI Database 750.

The FP-Growth algorithm significantly improves computational efficiency. By storing the entire dataset in a compact, memory-efficient FP-tree, the algorithm minimizes I/O costs, making it scalable for large datasets. This scalability is especially important for the Training Module 740, as it is required to assess extensive transactional data to generate recommendations.

In a non-limiting example, consider a retail dataset containing thousands of transactions, where each transaction is a list of products purchased by a customer. The FP-Growth algorithm can quickly identify frequent patterns like “if a customer buys bread, they are likely to buy butter,” thus providing actionable insights for cross-selling and up-selling strategies.

In an exemplary use case, the FP-Growth algorithm is configured to efficiently identify frequent itemsets in Training Module 740 based on historical sales data extracted from the BSS Database 760. The FP-Growth algorithm proceeds with its two-step process to find frequent patterns, which in this case are Service Plans often bought together by resellers. The algorithm eliminates a conventional need for multiple database scans and candidate generation, thereby reducing computational overhead. The flexibility in setting its parameters allows it to adapt to both specific and general datasets, making it versatile for various types of market analyses. This incorporation of the FP-Growth algorithm into the Training Module 740 ensures that the system can handle large datasets efficiently while providing accurate and useful recommendations.

The data, once fetched and validated by the Data Collection Module 720, is stored in a .CSV format in Storage 730. The algorithm's first step involves calculating the frequency of each Service Plan (PlanID) in the historical data. It sorts these Service Plans in descending order based on their frequency of occurrence. This step is vital for the Individual model, where the algorithm dynamically calculates the minimum support value based on the 25th percentile of reseller sales during a specific training date range. For the All model, a constant minimum support value of 0.00001 is applied to maintain broader applicability.

The FP-Growth algorithm then builds an FP-tree to encapsulate all critical information about the frequent itemsets in the dataset. Within the Training Module 740, each node in this tree corresponds to a Service Plan, and a counter on each node keeps track of how often a Service Plan appears together with other Service Plans in the data. This tree structure allows for efficient mining of association rules, which are the basis for generating FBT recommendations.

Both the Individual and All models use “Lift” as the minimum threshold metric, set at a value of 1.1. This metric helps to identify not just frequent, but also relevant associations between Service Plans. The models restrict the maximum number of associations to two: one for the bought Service Plan (antecedent) and one for the Service Plan bought together with it (consequent). These associations are then stored in the AI Database 750.

The FP-Growth algorithm's computational efficiency makes it especially suitable for the Training Module 740, given that it handles large volumes of historical data from the BSS Database 760. By utilizing an FP-tree, system 700 minimizes computational costs and improves the training process.

Thereby, the Training Module 740 uses the FP-Growth algorithm to train AI models capable efficiently and effectively sof identifying Service Plans that are frequently bought together. This implementation allows for dynamically adaptable and broadly applicable models, making the Training Module 740.

In some embodiments, Rosetta Table 715 is responsible for translating Plan IDs to hash IDs. It initially creates a table that links each PlanID with its associated resources. These resources undergo a process of deduplication and sorting. A SHA-256 hash function is then applied to these sorted sets to produce corresponding hash IDs. Additional attributes such as price and category are added to this mapping, and the enriched table is stored in the database.

The Business Filters 745 can be configured as algorithms encoded into the system, providing conditional statements and loops to filter out recommendations based on a set of pre-defined criteria. For example, the criteria can include checking for the active status of Service Plans in the Reseller Catalog, verifying that the recommended and requested product categories are distinct, and ensuring that the price of the recommended Service Plan does not exceed 40% of the initially requested one.

Output 770 provides data to a user interface where the filtered recommendations are displayed. The recommendations are presented as an array of Service Plan IDs after the Business Filters 745 have been applied.

These recommendations can be presented to the user in a “Frequently Bought Together” (FBT) display/interface. It's important to note that these recommendations are not static; the user has the freedom to add or remove any recommendation based on their preferences. This dynamic interaction with the recommendations enhances the user's experience.

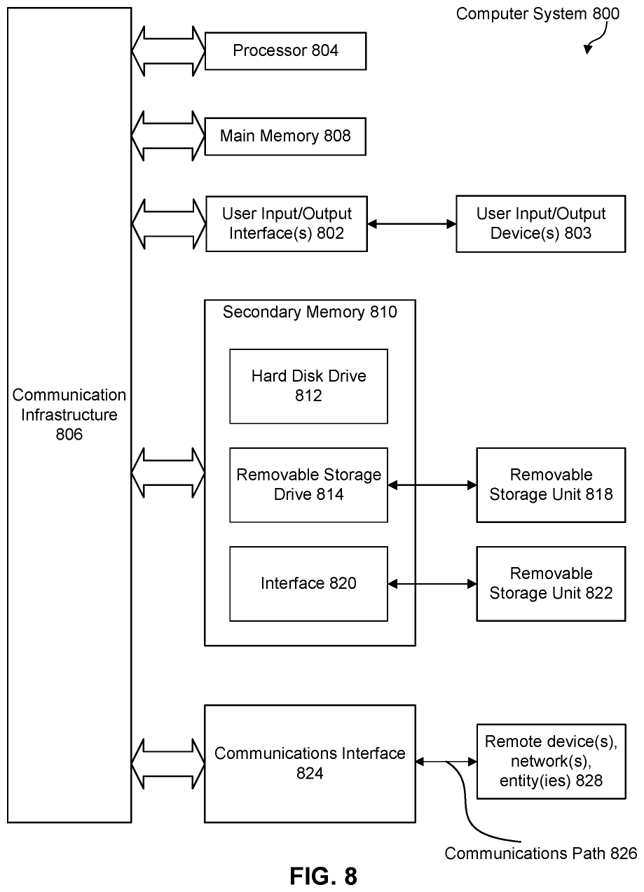

FIG. 8 is a block diagram of example components of device 800. One or more computer systems 800 may be used, for example, to implement any of the embodiments discussed herein, as well as combinations and sub-combinations thereof. Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random-access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814.

Removable storage drive 814 may interact with a removable storage unit 818. Removable storage unit 818 may include a computer-usable or readable storage device having stored thereon computer software (control logic) and/or data. Removable storage unit 818 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An automated recommendation system for product recommendations, comprising:
a server coupled to a processor, configured to:
receive a recommendation request from a user with an account identifier (AccountID) and a Service Plan ID (PlanID);
retrieve historical sales data using an artificial intelligence (AI) Microservice and store the data;
fetch pre-calculated association rules;
apply Business Filters to the association rules to match predetermined business rules;
generate recommendations using the filtered association rules and the historical sales data;
convert the recommendations to an output array of Service Plan IDs;
transmit the output array to a Frequently Bought Together (FBT) interface for user interaction; and
train the AI Microservice using association rules from the historical sales data, where the AI microservice employs an ensemble AI model with an Individual model and an All model that both utilize an FP-Growth algorithm, wherein the Individual model processes reseller-specific data, and wherein the All model refines recommendations using aggregated data.

2. The recommendation system of claim 1, wherein the association rules data sources comprise Hash recommendations.

3. The recommendation system of claim 1, wherein the server is configured to retrieve the historical sales data periodically, the system further including a Data Collection Component to extract historical sales data from a Business Support System Database, and store it in a storage element.

4. The recommendation system of claim 1, where the AI Microservice uses an ensemble AI model made up of an Individual model and an All model.

5. The recommendation system of claim 4, where the Individual model gives personalized recommendations using each reseller's specific sales data.

6. The recommendation system of claim 4, where the All model creates recommendations using aggregated data.

7. The recommendation system of claim 1, wherein Business Filters ensure recommended Service Plans are both active in the Reseller Catalog and satisfy particular pricing criteria.

8. The recommendation system of claim 1, where the AI Microservice offers several endpoints for updating the AI model, fetching FBT product recommendations, and acquiring business metrics.

9. A method for providing product recommendations based on Service Plan IDs, comprising:
receiving a user recommendation request with account identifiers and Service Plan IDs;
obtaining pre-calculated association rules;
applying Business Filters to the association rules to produce relevant recommendations;
transforming these recommendations into an output array; and
displaying the output array on a Frequently Bought Together (FBT) interface.

10. The method of claim 9, wherein the data sources for association rules include Hash recommendations.

11. The method of claim 9, also involving extracting historical sales data from a Business Support System Database for performing an artificial intelligence (AI) process.

12. The method of claim 9, wherein transforming these recommendations into an output array comprises an AI Microservice employing an ensemble AI model, including an Individual model and an All model.

13. The method of claim 12, where the Individual model trains data for personalized recommendations using sales data specific to individual resellers.

14. The method of claim 12, where the All model trains data leveraging aggregated data for recommendation creation.

15. The method of claim 9, wherein Business Filters verify that recommended Service Plans are both active in the Reseller Catalog and meet designated pricing criteria.

16. The method of claim 9, where the AI Microservice provides various endpoints for AI model updates, FBT product recommendation retrieval, and business metric acquisition.

17. A non-transitory computer-readable device with instructions that, when executed, cause a device to:
obtain a user recommendation request with account identifiers and Service Plan IDs;
fetch pre-calculated association rules;
apply Business Filters to these rules, producing relevant recommendations;
transform these recommendations to an output array; and
display the output array in a Frequently Bought Together (FBT) interface.

18. The computer-readable device of claim 17, where the All model uses aggregated data for its recommendations.

19. The computer-readable device of claim 17, wherein Business Filters confirm that the recommended Service Plans are both present in the Reseller Catalog and match specific pricing guidelines.

20. The computer-readable device of claim 17, where an artificial intelligence (AI) Microservice is provided with endpoints for AI model training, FBT product recommendation fetching, and business metric retrieval.
